(19) United States
(12) Patent Application Publication
(10) Pub. No.: US 2012/0305369 A1
(43) Pub. Date: Dec. 6, 2012

(54) Apparatus and Method for Remotely Racking Circuit Breakers and Contactors

(75) Inventors: Chester Levi Greer, Baton Rouge, LA (US); Michael J. Schilling, French Settlement, LA (US)

(73) Assignee: inoLECT, LLC, Baton Rouge, LA (US)

(21) Appl. No.: 13/207,828

(22) Filed: Aug. 11, 2011

Related U.S. Application Data
(60) Provisional application No. 61/492,327, filed on Jun. 1, 2011.

(51) Int. Cl. H01H 9/20

(52) U.S. Cl. 200/50.24

(57) ABSTRACT

An apparatus, system and method are provided for remotely racking circuit breakers and contactors that are housed within a housing structure, such as a circuit breaker cell or switchgear cabinet, and that function via a levering mechanism.

### CROSS-REFERENCE TO RELATED APPLICATION

This application claims benefit to provisional application 61/492,327 filed on Jun. 1, 2011.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The present disclosure relates to subject matter for remotely racking a circuit breaker, particularly subject matter including a force amplifying or levering mechanism for locking the breaker in each of its plurality of positions automatically without the need for operator intervention to determine how far the circuit breaker must be displaced to place it in the desired position.

2. Description of Related Art

In utility and industrial applications, circuit breakers and contractors are utilized to establish electrical circuits. From time to time, maintenance requirements (e.g. repair, replacement, or load control) necessitate racking operations to disconnect (“rack out”) and connect (“rack in”) these breakers or contactors. During these operations, electrical circuits may short-circuit and produce a dangerous condition known as an arc flash.

Arc-flash occurs when an electric current passes through air when insulation or isolation between electrified conductors is insufficient to withstand the applied voltage. During an arc flash, temperatures rapidly escalate causing conductors to melt, vaporize, and expand to several thousand times their normal volume, which generates a pressure wave carrying molten metal capable of hitting surfaces with forces of several hundred pounds per square inch. As a result, maintenance personnel must possess a means and method for safely performing racking operations to prevent injury or death from an arc-flash.

In the past, maintenance personnel have utilized personal protective equipment (PPE) to reduce exposure to potential arc flash hazards. However, PPE alone will not eliminate the risk of injury or death because personnel are still in close proximity to the circuit breaker during racking operations. In order to mitigate the likelihood of injury or death further, personnel must perform racking operations a safe distance from the circuit breaker, i.e. remotely.

The process for racking circuit breakers depends primarily upon the circuit breaker configuration. Circuit breakers typically have two configurations—horizontal and vertical. Racking operations on a horizontal breaker commonly occur by horizontally moving the circuit breaker within its cabinet or cell housing an elongated shaft that is coupled to the circuit breaker. As the shaft rotates, the circuit breaker moves horizontally within its cabinet until it is either disconnected (“racked out”) or connected (“racked in”) from its power terminals. Certain other designs do not utilize the rotating shaft mechanism. Instead, these other design utilize a simple lever system to engage or disengage its power terminals.

In a vertical circuit breaker configuration, racking out occurs by vertically lowering the circuit breaker to disengage its power terminals and subsequently moving it horizontally out of the cabinet. Racking in occurs by horizontally moving the circuit breaker back into the cabinet and elevating it into conductive contact with the switchgear power terminals.

U.S. Pat. No. 6,897,388 discloses an apparatus and method for remotely moving a horizontal type circuit breaker into or from circuit breaker cell housing. However, this apparatus and method cannot perform racking operations on a circuit breaker without a rotationally driven racking mechanism. Thus, a need exists for more versatile apparatus and method for remotely racking circuit breakers that function via a levering mechanism.

### BRIEF SUMMARY OF THE INVENTION

The object of this invention is to provide a more versatile apparatus and method for remotely racking circuit breakers and contactors, particularly circuit breakers and contactors that operate without a rotationally driven racking mechanism, i.e. breakers and contactors that operate via a levering mechanism.

For purposes of illustration, the invention will be described as applied to low voltage circuit breakers. However, the invention may also be applied to other types of electrical apparatus (e.g., without limitation, circuit switching devices and other circuit interrupters such as contactors, motor starters, motor controllers and other load controllers) housed within a housing structure, such as a circuit breaker cell or switchgear cabinet.

One aspect of this invention is an apparatus comprising a linear motion adapter. The linear motion adapter comprises a support bracket having a drive pedestal, and an actuating assembly. The support bracket is also provided with a coupling means for mounting the support bracket to a remote racking apparatus motor mount structure. The support bracket is also equipped with a fastener to maintain the support bracket in position, and bracket clamp wings for connecting the linear motion adapter to a cell bracket clamp with a fastener. The cell bracket clamp is fastened to a circuit breaker cell housing.

The drive pedestal extends substantially vertically from the support bracket. The drive pedestal comprises a supporting structure capable of supporting a rotatable drive shaft. The rotatable drive shaft is coupled to an adapter connection and an adapter wheel. The adapter wheel is directly coupled to the rotatable drive shaft and connected to a corresponding wheel on the actuating assembly by a link.

The actuating assembly comprises a driving member, such as an acme screw, having an actuating assembly wheel and a pull bar structure. The actuating assembly also has mounting pedestals on each of its ends that are coupled to the support bracket.

The pull bar structure is equipped with a breaker pull adapter designed to interface with a circuit breaker actuating assembly. In the preferred embodiment, the breaker pull adapter is a block with a groove designed to engage a pull adapter shaft. The breaker pull adapter is coupled to the pull bar structure with a fastener. In addition, the pull bar structure also has position magnets that are utilized for monitoring the position of the pull bar structure during racking operations.

A second aspect of this invention is a circuit breaker actuating assembly comprising a frame, an actuator assembly, and a position pin lever. The frame comprises at least two breaker mounting brackets arranged parallel to one another and connected together with cross bracing comprising at least one hook bracket, at least one pull adapter shaft, and at least one support shaft. The hook bracket is connected to the breaker mounting brackets by a fastener.

The breaker mounting brackets are also provided with a hook or hooks to mount or anchor the circuit breaker actuating assembly to a circuit breaker frame. The hooks are connected to the breaker mounting brackets with a fastener. The breaker mounting brackets are also provided with apertures to facilitate a connection with the pull adapter shaft, and the support shaft. The pull adapter shaft is inserted into the aperture and maintained in position by a fastener. Likewise, the support shaft is inserted into the aperture and maintained in position by a fastener.

The support shaft is coupled to the actuator assembly with a fastener. The support shaft supports the linear actuator. The support shaft is also coupled to the position pin lever. The position pin lever engages a position pin on the circuit breaker during racking operations. The hook bracket is coupled to an actuator stabilizer with a fastener.

The actuator assembly comprises a linear actuator and an actuator arm. The actuator arm comprises an actuator arm pivot and an actuator arm end connector. The linear actuator is coupled to the actuator arm with a fastener. The actuator arm end connector is coupled to the circuit breaker lever with a fastener adapted to engage a circuit breaker lever. The linear actuator is connected to a remote racking apparatus controller by an electrical cable allowing an operator to control the linear actuator and perform racking operations with a control station.

In an alternative embodiment of the circuit breaker actuating assembly, the support shaft also functions as the pull adapter shaft. In this alternative embodiment, the circuit breaker actuating assembly comprises a frame, an actuator assembly, and a position pin lever. The frame comprises at least two breaker mounting brackets arranged parallel to one another and connected together with cross bracing comprising at least one hook bracket, and at least one support shaft. The hook bracket is connected to the breaker mounting brackets by a fastener. Alternatively, the hook bracket could be fused or welded to the breaker mounting brackets.

The breaker mounting brackets are also provided with a hook or hooks to mount or anchor the circuit breaker actuating assembly to a circuit breaker frame. The hooks are connected to the breaker mounting brackets with a fastener, although hooks could alternatively be fused or welded to the breaker mounting bracket. The breaker mounting brackets are also provided with apertures to facilitate a connection with the support shaft. The support shaft is inserted into the aperture and maintained in position by a fastener.

The support shaft is coupled to the actuator assembly with a fastener. The support shaft supports the linear actuator. The support shaft is also coupled to the position pin lever. The position pin lever engages a position pin on the circuit breaker during racking operations. The hook bracket is coupled to an actuator stabilizer with a fastener. The actuator stabilizer provides additional support for the actuator assembly and maintains the actuator assembly in position.

The actuator assembly comprises a linear actuator and an actuator arm. The actuator arm comprises an actuator arm pivot and an actuator arm end connector. The linear actuator is coupled to the actuator arm with a fastener. The actuator arm end connector is coupled to the circuit breaker lever with a fastener adapted to engage a circuit breaker lever. The linear actuator is connected to the remote racking apparatus controller by an electrical cable allowing an operator to control the linear actuator and perform racking operations with a control station.

A third aspect of this invention is an apparatus for use with a remote racking apparatus comprising a linear motion adapter and a circuit breaker actuating assembly. Another aspect of the invention is a method for remotely rack a circuit breaker. An operator begins racking operations by attaching the linear motion adapter to the remote racking unit by sliding the linear motion adapter onto the motor mount structure and fastening it into position. The operator couples the adapter connection to the remote racking apparatus adapter structure. Next, the remote racking unit is moved into position near the circuit breaker cell. The operator then connects the circuit breaker actuating assembly to the circuit breaker frame. Next, the actuator end arm connector is coupled to the circuit breaker lever, and the cell bracket clamps are coupled to the circuit breaker cell housing. The position pin lever is coupled to the position pin to facilitate removal of the circuit breaker. The operator then connects the cell bracket clamps to the bracket clamp wings. The breaker pull adapter is connected to the pull adapter shaft.

In order to disconnect the breaker (“racking out”), the position pin lever disengages the position pin. The operator takes a control station and moves to a safe distance and location from the circuit breaker to perform racking operations. Using the control station, the operator commands and directs the gear motor to move the breaker as required. The control station prompts the operator for required actions and inputs.

Once the operator is in a safe location, the operator uses the control station to rack out the breaker. The controller is pre-programmed with a racking procedure that is based on the circuit breaker manufacturer's racking guidelines. The program varies based on the circuit breaker manufacturer, but can be easily modified to accommodate breakers of different manufacturers.

In order to connect the breaker (“racking in”), the operator takes a control station and moves to a safe distance and location from the circuit breaker to perform racking operations. The operator uses the control station to rack in the breaker. The controller is pre-programmed with a racking procedure that is based on the circuit breaker manufacturer's racking guidelines. The program varies based on the circuit breaker manufacturer, but can be easily modified to accommodate breakers of different manufacturers.

### BRIEF DESCRIPTION OF THE SEVERAL VIEWS OF THE DRAWING(S)

FIG. 1 is a side view of a remote racking apparatus.

FIG. 2 is a front and side view of the linear motion adapter.

FIG. 3 is a front and side view of the circuit breaker actuating assembly.

FIG. 4 is a front and side view of a circuit breaker and circuit breaker cell housing.

### DETAILED DESCRIPTION OF THE INVENTION

For purposes of illustration, the invention will be described as applied to low voltage circuit breakers. However, the invention may also be applied to other types of electrical apparatus (e.g., without limitation, circuit switching devices and other circuit interrupters such as contactors, motor starters, motor controllers and other load controllers) housed within a housing structure, such as a circuit breaker cell or switchgear cabinet.

Directional phrases used herein relate to the orientation of the elements shown in the drawings and are not limiting upon the claims unless expressly recited therein. For example, left, right, top, bottom, clockwise, counterclockwise and derivatives thereof.

As employed herein, the term “fastener” refers to any suitable connecting, coupling, or tightening mechanism expressly including, but not limited to, screws, bolts, pins, and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

As employed herein, the term “racking” refers to any suitable manipulation of an electrical apparatus, such as a circuit breaker, with respect to a housing structure (e.g., without limitation, switchgear cabinet) and expressly includes, without limitation, insertion or removal of the circuit breaker from the switchgear cabinet.

As employed herein, the term “link” refers to any known or suitable mechanism (e.g., without limitation, a cable; a wire; a chain; a number of interconnected links; a rigid member such as a socket extension) for interconnecting one component to another in order to provide mechanical communication there between.

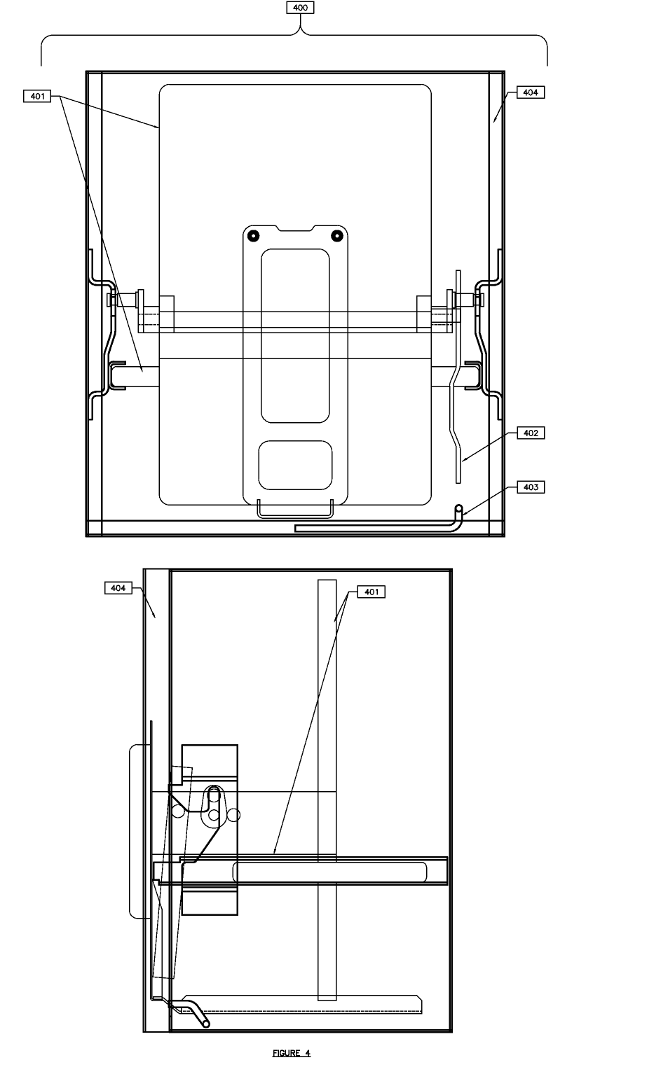

A low voltage circuit breaker inside its cell housing is shown generally in FIG. 4 at 400. The low voltage circuit breaker is illustrated for reference purposes only. The invention may also be applied to other types of electrical apparatus (e.g., without limitation, circuit switching devices and other circuit interrupters such as contactors, motor starters, motor controllers and other load controllers) housed within a housing structure, such as a circuit breaker cell housing or switchgear cabinet.

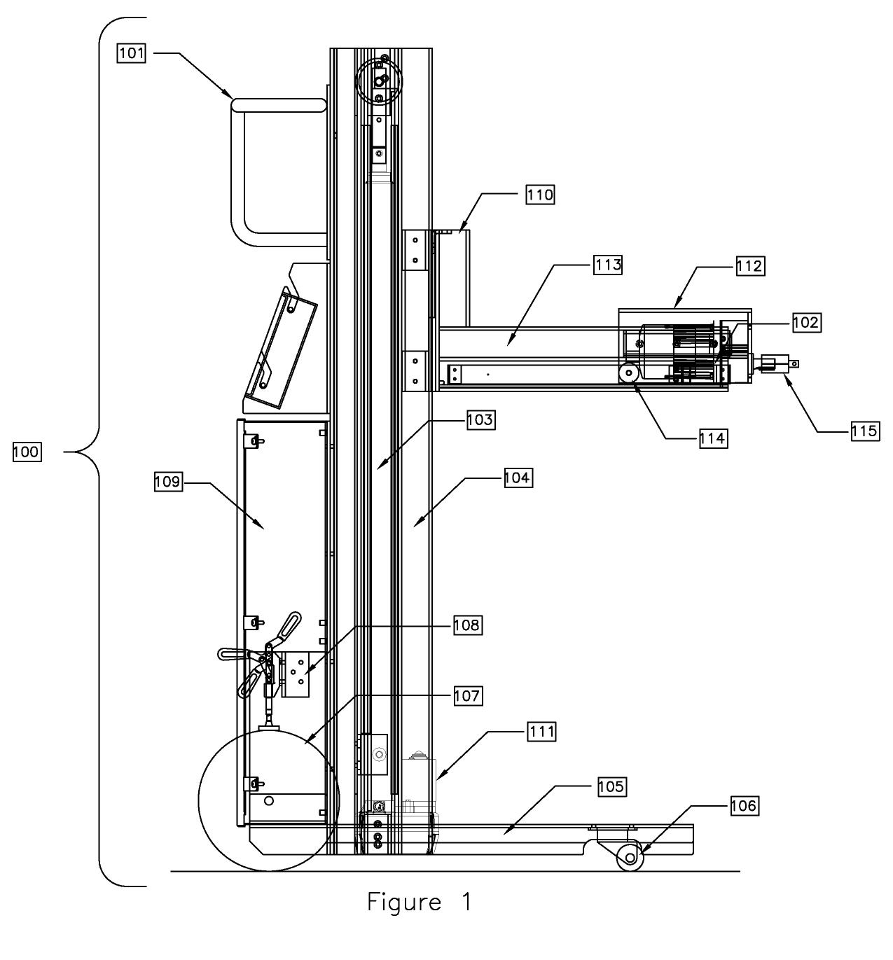

A remote racking unit used in accordance with this invention is shown generally in FIG. 1 at 100. The remote racking unit 100 comprises a stationary vertical support 103 fixed to a racking unit base 105. The stationary vertical support 103 and racking unit base 105 remain stationary and are in a fixed position at all times.

The racking unit base 105 is equipped with at least one front wheel 106 and at least one rear wheel 107. The front wheel 106 is preferably a caster type wheel that enables turning of the remote racking unit 100. The rear wheel 107 is preferably a flat free style wheel that is larger than the front wheel 106 and allows an operator to easily move the remote racking unit 100. Both the front 106 and rear wheel 107 are coupled to the racking unit base 105.

The remote racking unit also has an intermediate structural support 104, which is engaged in a low friction substantially vertical sliding relationship with the stationary vertical support 103. The intermediate structural support 104 moves vertically with respect to the stationary vertical support 103, but it is not directly connected to the stationary vertical support 103. The stationary structural support 103 provides a guiding means for guiding and moving the intermediate structural support 104 along the vertical axis.

An actuator is coupled to the bottom of the stationary vertical support 103 and to the top of the intermediate structural support 104. An actuator 111 is utilized to move the intermediate structural support 104 along the vertical axis. As the actuator 111 extends, the intermediate structural support 104 moves upwardly as well. As the actuator 111 retracts, the intermediate structural support 104 moves downwardly.

The remote racking unit is also provided with a motor mount structure 113 having a sliding motor structure 110. The motor mount structure 113 provides a means to support a motor 102 and also allows the motor 102 to slide forward and backward along the horizontal axis. Not shown is a link that is connected to the top portion of the stationary vertical support 103 and passes over the top of the intermediate structural support 104 and then extends downward and attaches to the sliding motor structure 110. As the intermediate structural support 104 extends upward, the link is pulled over the top of the intermediate structural support 104 resulting in the vertical movement of the sliding motor structure 110 at a 2:1 ratio, i.e. for every inch that the intermediate structural support 104 moves vertically, the sliding motor structure 110 moves vertically by a multiple of 2.

The sliding between supports is accomplished by placing wear resistant slippery nylon (not shown) in the area between the supports to eliminate contact friction. The nylon is located at the top of the stationary structural support 103, the top of the intermediate structural support 104, and along the entire length of the sliding motor structure 110. The stationary structural support 103, intermediate structural support 104, sliding motor structure 110, and motor mount structure 113 are all made of extruded aluminum that is anodized for premier performance, quality, and corrosion resistance with a limited coefficient of friction.

The motor 102 is supported by the motor mount structure 113. The motor 102 is preferably a three phase racking motor. The motor is also provided with a shaft and adapter structure 115. The adapter structure is fabricated and arranged to be coupled with a horizontally configured circuit breaker. Alternatively, the adapter structure 115 may be coupled to an adapter, such as a linear motion adapter 200, for racking operations of breakers that do not have rotational racking mechanisms, e.g. levering mechanisms.

The remote racking unit has a control box 109 that houses the electronic controls of the unit. The electronic controls comprise a variable frequency drive and a controller, such as a programmable logic controller (PLC); however, the electronic controls are not limited to these items. The control box 109 is attached to the racking unit base 105 and to the vertical member 103. The variable frequency drive and programmable logic controller in the control box 109 control the motor 102. The motor 102 may slide back and forth with the breaker along the motor mount structure 113. A motor housing 112 houses the motor 102. The motor housing 112 provides shielding for motor 102. The motor housing 112 is maintained in the forward position by the constant force springs 114, which allows the motor 102 to be in constant engagement with the breaker or adapter it is operating.

In addition, the remote racking unit 100 may also have a brake assembly 108 that allows an operator to maintain the remote racking unit 100 in position during racking operations. The brake assembly 108 is attached to the racking unit base 105 and interacts with the rear wheel 107. An encoder is mounted to the motor 102. The encoder mounted to the motor 102 and the constant force springs 114 mounted on the horizontal motor carriage 113 track both circuit breaker and racking unit movement and position.

The remote racking unit 100 is controlled from a control station (not shown), preferably a touch screen device. In one embodiment of the invention, the control station is connected to the device control box 109 by a 75 Ft communications/control cable. In another embodiment of the invention, the control station wirelessly communicates with the device control box 109. The remote racking unit 100 utilizes standard 120 Volt A.C. power, and does not require any interconnection with circuit breaker or switchgear wiring or controls.

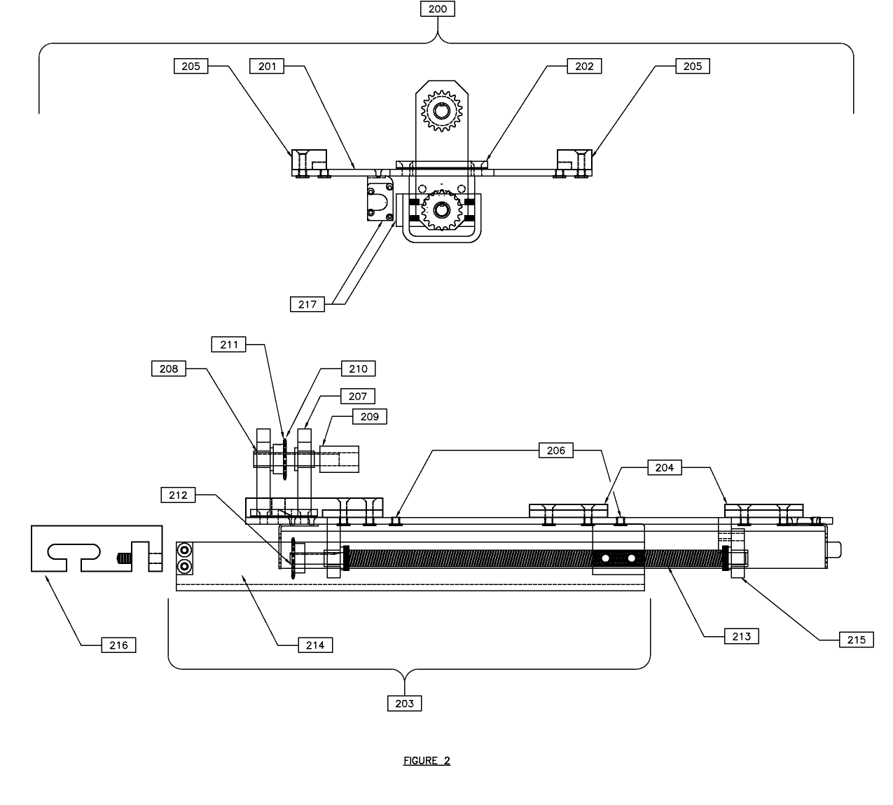

A linear motion adapter in accordance with the present invention is shown generally in FIG. 2 at 200. The linear motion adapter comprises a support bracket 201 having a drive pedestal 202, and an actuating assembly 203. The support bracket is provided with a coupling means 204 for mounting the support bracket 201 to the remote racking apparatus motor mount structure 113. The coupling means 204 is preferably a slide connection adapted to engage the motor mount structure 113. The coupling means 204 mates with an edge of the motor mount structure 113 allowing an operator to slide the linear motion adapter into position. The support bracket 201 is also equipped with a fastener 206 to maintain the support bracket 201 in position once it is attached to the motor mount structure 113. The coupling means 204 and fastener 206 on the support bracket allows an operator to quickly and easily attach or detach the linear motion adapter.

The support bracket 201 also includes bracket clamp wings 205 for connecting the linear motion adapter 200 to a cell bracket clamp with a fastener. The cell bracket clamp is fastened to a circuit breaker cell housing 404 to maintain the remote racking unit 100 in position.

The drive pedestal 202 extends substantially vertically, preferably orthogonally, from the support bracket 201. The drive pedestal 202 comprises a supporting structure 207 capable of supporting a rotatable drive shaft 208. The rotatable drive shaft 208 is coupled to an adapter connection 209 and an adapter wheel 210. The adapter connection 209 preferably comprises a socket connection shaped to engage the remote racking apparatus adapter structure 115. The adapter wheel 210 is directly coupled to the rotatable drive shaft 208 and connected to a corresponding wheel 212 on the actuating assembly by a link 211. The adapter wheel 210 is preferably a sprocket wheel and the link is preferably a chain.

The actuating assembly comprises a driving member 213, such as an acme screw, having an actuating assembly wheel 212 and a pull bar structure 214. The actuating assembly also has mounting pedestals 215 on each of its ends that are coupled to the support bracket 201. The actuating assembly wheel 212 is preferably a sprocket wheel. As discussed above, the actuating assembly wheel 212 is linked to the adapter wheel 210 on the rotatable drive shaft 208. As the adapter structure 115 rotates, the rotatable drive shaft 208 and adapter wheel 210 also rotate causing the corresponding actuating assembly wheel 212 to rotate. The acme screw 213 translates the rotational motion of the actuating assembly wheel 212 into linear motion allowing the pull bar structure 214 to extend and retract depending on the rotational direction of the adapter structure 115.

The pull bar structure 214 is equipped with a breaker pull adapter 216 designed to interface with a circuit breaker actuating assembly. In the preferred embodiment, the breaker pull adapter 216 is a block with a groove designed to engage a pull adapter shaft 303 or a support shaft 312. The breaker pull adapter 216 is coupled to the pull bar structure 214 with a fastener. In addition, the pull bar structure 214 also has position magnets 217 that are utilized for monitoring the position of the pull bar structure 214 during racking operations.

Although the linear motion adapter 200 is described in relation to the remote racking unit 100 shown in FIG. 1, the linear motion adapter is not limited to this embodiment of the remote racking unit. The shape and dimensions of the linear motion adapter's support bracket 201 could be modified by one of ordinary skill in the art to fit virtually any remote racking unit with a motor and motor mount structure.

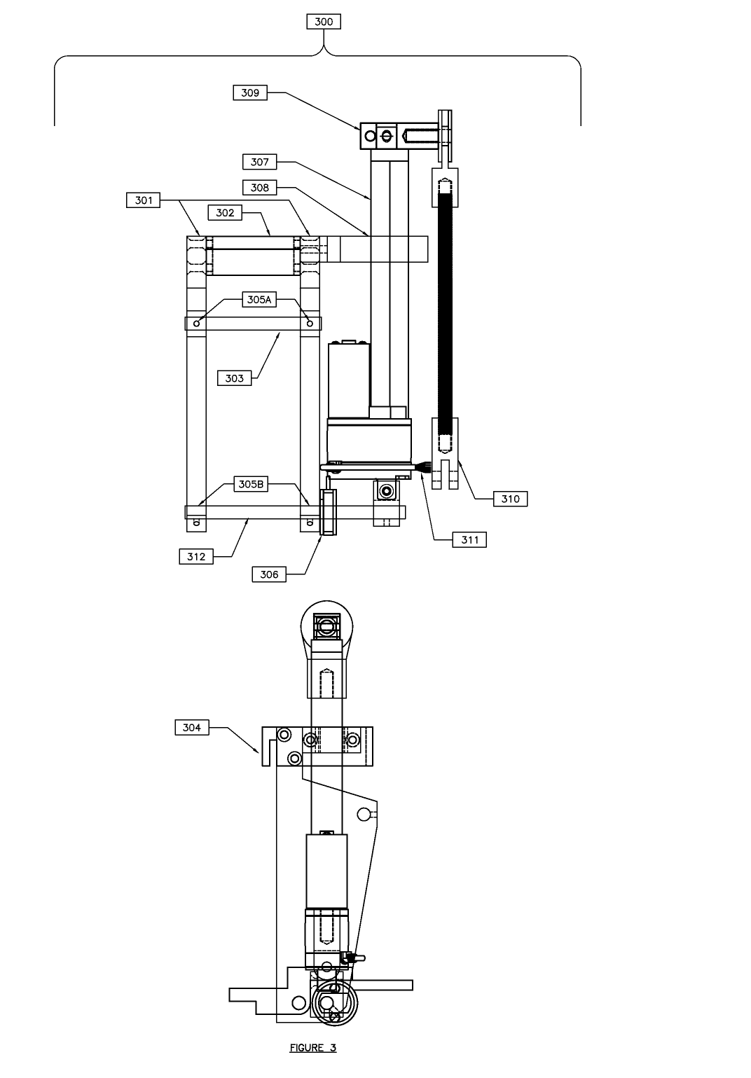

One embodiment of a circuit breaker actuating assembly is shown generally in FIG. 3 at 300. The circuit breaker actuating assembly 300 comprises a frame, an actuator assembly, and a position pin lever 306. The frame comprises at least two breaker mounting brackets 301 arranged parallel to one another and connected together with cross bracing comprising at least one hook bracket 302, at least one pull adapter shaft 303, and at least one support shaft 312. The hook bracket 302 is connected to the breaker mounting brackets 301 by a fastener. Alternatively, the hook bracket 302 could be fused or welded to the breaker mounting brackets 301. In addition, the circuit breaker actuating assembly may have more than one actuator assembly depending upon the circuit breaker configuration.

The breaker mounting brackets 301 are also provided with a hook or hooks 304 to mount or anchor the circuit breaker actuating assembly 300 to a circuit breaker frame 401. The hooks 304 are connected to the breaker mounting brackets 301 with a fastener, although hooks 304 could alternatively be fused or welded to the breaker mounting bracket 301. The breaker mounting brackets 301 are also provided with apertures 305a, 305b to facilitate a connection with the pull adapter shaft 303 and the support shaft 312. The pull adapter shaft 303 is inserted into the aperture 305 and maintained in position by a fastener. Likewise, the support shaft 312 is inserted into the aperture and maintained in position by a fastener.

The support shaft 312 is coupled to the actuator assembly with a fastener. The support shaft 312 supports the linear actuator 307. The support shaft 312 is also coupled to the position pin lever 306. The position pin lever 306 engages a position pin 403 on the circuit breaker 400 during racking operations. The hook bracket 302 is coupled to an actuator stabilizer 308 with a fastener. The actuator stabilizer 308 provides additional support for the actuator assembly and maintains the actuator assembly in position.

The actuator assembly comprises a linear actuator 307 and an actuator arm. The actuator arm comprises an actuator arm pivot 309 and an actuator arm end connector 310. The linear actuator 307 is coupled to the actuator arm with a fastener. The actuator arm end connector 310 is coupled to the circuit breaker lever 402 with a fastener adapted to engage a circuit breaker lever 402. The linear actuator 307 is connected to the remote racking apparatus controller by an electrical cable 311 allowing an operator to control the linear actuator 307 and perform racking operations with a control station, e.g. a touch screen panel. The motion of the linear actuator 307 moves the actuator arm providing the necessary force to actuate the circuit breaker lever 402 during racking operations.

In an alternative embodiment of the circuit breaker actuating assembly (not shown), the support shaft also functions as the pull adapter. In this alternative embodiment, the circuit breaker actuating assembly 300 comprises a frame, an actuator assembly, and a position pin lever 306. The frame comprises at least two breaker mounting brackets 301 arranged parallel to one another and connected together with cross bracing comprising at least one hook bracket 302, and at least one support shaft 312. The hook bracket 302 is connected to the breaker mounting brackets 301 by a fastener. Alternatively, the hook bracket 302 could be fused or welded to the breaker mounting brackets 301.

The breaker mounting brackets 301 are also provided with a hook or hooks 304 to mount or anchor the circuit breaker actuating assembly 300 to a circuit breaker frame 401. The hooks 304 are connected to the breaker mounting brackets 301 with a fastener, although hooks 304 could alternatively be fused or welded to the breaker mounting bracket 301. The breaker mounting brackets 301 are also provided with apertures 305b to facilitate a connection with the support shaft 312. The support shaft 312 is inserted into the aperture and maintained in position by a fastener.

The support shaft 312 is coupled to the actuator assembly with a fastener. The support shaft 312 supports the linear actuator 307. The support shaft 312 is also coupled to the position pin lever 306. The position pin lever 306 engages a position pin 403 on the circuit breaker 400 during racking operations. The hook bracket 302 is coupled to an actuator stabilizer 308 with a fastener. The actuator stabilizer 308 provides additional support for the actuator assembly and maintains the actuator assembly in position.

The actuator assembly comprises a linear actuator 307 and an actuator arm. The actuator arm comprises an actuator arm pivot 309 and an actuator arm end connector 310. The linear actuator 307 is coupled to the actuator arm with a fastener. The actuator arm end connector 310 is coupled to the circuit breaker lever 402 with a fastener adapted to engage a circuit breaker lever 402. The linear actuator 307 is connected to the remote racking apparatus controller by an electrical cable 311 allowing an operator to control the linear actuator 307 and perform racking operations with a control station, e.g. a touch screen panel. The motion of the linear actuator 307 moves the actuator arm providing the necessary force to actuate the circuit breaker lever 402 during racking operations. In addition, in an alternative embodiment the actuator assembly may also serve and function as the breaker mounting brackets 301.

Another aspect of the invention is a method for remotely rack a circuit breaker. An operator begins racking operations by attaching the linear motion adapter to the remote racking unit by sliding the linear motion adapter onto the motor mount structure and fastening it into position. The operator couples the adapter connection 209 to the remote racking apparatus adapter structure 115. Next, the remote racking unit is moved into position near the circuit breaker cell 400. The operator then connects the circuit breaker actuating assembly to the circuit breaker frame. Next, the actuator end arm connector is coupled to the circuit breaker lever, and the cell bracket clamps are coupled to the circuit breaker cell housing. The position pin lever 306 is coupled to the position pin 403 to facilitate removal of the circuit breaker 400. The operator then connects the cell bracket clamps to the bracket clamp wings 205. The breaker pull adapter 216 is connected to the pull adapter shaft 303 or support shaft 312.

In order to disconnect the breaker (“racking out”), the position pin lever 306 disengages the position pin 403. The operator takes a control station and moves to a safe distance and location from the circuit breaker to perform racking operations. Using the control station, the operator commands and directs the gear motor to move the breaker as required. The control station prompts the operator for required actions and inputs.

Once the operator is in a safe location, the operator uses the control station to rack out the breaker. The controller is pre-programmed with a racking procedure that is based on the circuit breaker manufacturer's racking guidelines. The program varies based on the circuit breaker manufacturer, but can be easily modified to accommodate breakers of different manufacturers.

In order to connect the breaker (“racking in”), the operator takes a control station and moves to a safe distance and location from the circuit breaker to perform racking operations. The operator uses the control station to rack in the breaker. The controller is pre-programmed with a racking procedure that is based on the circuit breaker manufacturer's racking guidelines. The program varies based on the circuit breaker manufacturer, but can be easily modified to accommodate breakers of different manufacturers.

Any reference to patents, documents and other writings contained herein shall not be construed as an admission as to their status with respect to being or not being prior art. It is understood that the array of features and embodiments taught herein may be combined and rearranged in a large number of additional combinations not directly disclosed, as will be apparent to one having skill in the art.

There are, of course, other alternate embodiments, which are obvious from the foregoing descriptions of the invention, which are intended to be included within the scope of the invention, as defined by the following claims.

What is claimed is:

1. A linear motion adapter coupled to a remote racking apparatus having an adapter structure for remotely connecting and disconnecting a circuit breaker or contactor from a cell housing, the linear motion adapter comprising:
a. a support bracket with a coupling means for mounting the support bracket to the remote racking apparatus;
b. a drive pedestal;
c. a rotatable drive shaft with an adapter connection; and
d. an actuating assembly coupled to the support bracket;

2. The linear motion adapter of claim 1, wherein said linear motion adapter further comprises an adapter wheel coupled to the rotatable drive shaft.

3. The linear motion adapter of claim 2, wherein said actuating assembly further comprises a driving member, an actuating assembly wheel connected to the adapter wheel by a link, and a pull bar structure.

4. The linear motion adapter of claim 3, wherein said drive pedestal extends substantially vertically from the support bracket.

5. The linear motion adapter of claim 4, wherein said adapter connection further comprises a socket connection shaped to engage the remote racking apparatus adapter structure.

6. The linear motion adapter of claim 5, wherein said adapter wheel is a sprocket wheel.

7. The linear motion adapter of claim 6, wherein said assembly wheel is a sprocket wheel, and said driving member is an acme screw.

8. The linear motion adapter of claim 7, wherein said actuating assembly is coupled to the support bracket by a mounting pedestal;

9. The linear motion adapter of claim 8, wherein said linear motion adapter further comprises a breaker pull adapter coupled to the actuating assembly wherein said breaker pull adapter is a block with a groove.

10. A circuit breaker actuating assembly for remotely connecting and disconnecting a circuit breaker or contactor from a cell housing, the circuit breaker actuating assembly comprising:
a. a frame;
b. an actuator assembly; and
c. a position pin lever;

11. The circuit breaker actuating assembly of claim 10, wherein said frame further comprises at least two breaker mounting brackets arranged parallel to one another, said breaker mounting brackets connected together with cross bracing, said cross bracing comprising at least one hook bracket, and at least one support shaft.

12. The circuit breaker actuating assembly of claim 11, wherein said hook bracket is connected to the breaker mounting brackets.

13. The circuit breaker actuating assembly of claim 12, wherein said breaker mounting brackets are provided with a hook to mount or anchor the circuit breaker actuating assembly to a circuit breaker frame.

14. The circuit breaker actuating assembly of claim 13, wherein said breaker mounting brackets are provided with apertures to facilitate a connection with the support shaft.

15. The circuit breaker actuating assembly of claim 14, wherein said support shaft is coupled to the actuator assembly and the position pin lever.

16. The circuit breaker actuating assembly of claim 15, wherein said hook bracket is coupled to an actuator stabilizer.

17. The circuit breaker actuating assembly of claim 16, wherein said cross bracing further comprises at least one pull adapter shaft.

18. The circuit breaker actuating assembly of claim 10, wherein said actuator assembly further comprises:
a. a linear actuator; and
b. an actuator arm coupled to the linear actuator.

19. The circuit breaker actuating assembly of claim 18, wherein said actuator arm further comprises:
a. an actuator arm pivot;
b. an actuator arm end connector; and
c. an electrical cable connected to a controller allowing an operator to control the linear actuator remotely.

20. A method for remotely racking a circuit breaker or contactor comprising the following steps:
a. attaching a linear motion adapter to a remote racking apparatus with an adapter structure;
b. coupling an adapter connection to the remote racking apparatus adapter structure;
c. positioning the remote racking apparatus near a circuit breaker cell;
d. connecting an actuating assembly to a circuit breaker frame;
e. coupling an actuator end arm connector to a circuit breaker lever;
f. coupling a cell bracket clamp to a circuit breaker cell housing;
g. coupling a position pin lever to a position pin;
h. connecting the cell bracket clamp to a bracket clamp wing; and connecting a breaker pull adapter to a pull adapter shaft or a support shaft.

21. An adapter system coupled to a remote racking apparatus having an adapter structure for remotely connecting and disconnecting a circuit breaker or contactor from a cell housing, the adapter system comprising:
a. a linear motion adapter wherein the linear motion adapter comprises:
i. a support bracket with a coupling means for mounting the support bracket to the remote racking apparatus;
ii. a drive pedestal;
iii. a rotatable drive shaft with an adapter connection; and
iv. an actuating assembly coupled to the support bracket;
b. a circuit breaker actuating assembly coupled to the linear motion adapter wherein the circuit breaker actuating assembly comprises:
i. a frame;
ii. an actuator assembly;
iii. a position pin lever;
iv. a linear actuator; and
v. an actuator arm coupled to the linear actuator.
